(19) United States
(12) Patent Application Publication
(10) Pub. No.: US 2005/0168426 A1
(43) Pub. Date: Aug. 4, 2005

(54) Liquid crystal display

(76) Inventors: Seong-Hwan Moon, Seoul (KR); Sang-Soo Kim, Seoul (KR)

Correspondence Address: MCGUIREWOODS, LLP, 1750 TYSONS BLVD, SUITE 1800, MCLEAN, VA, 22102, US

(21) Appl. No.: 11/049,677

(22) Filed: Feb. 4, 2005

Related U.S. Application Data
(63) Continuation of application No. 09/556,779, filed on Apr. 25, 2000.

(30) Foreign Application Priority Data
May 21, 1999 (KR) 1999-18518

(51) Int. Cl. G09G 3/36

(52) U.S. Cl. 345/98; 345/87

(57) ABSTRACT

Disclosed is an improved liquid crystal display to minimize delays of data signals and control signals on source PCB and the EMI. The liquid crystal display includes a wire aggregation that is arranged on a source PCB. The wire aggregation transmits signals including data signals, control signals, and clock signals of Which frequency is lowered to a half. The wire aggregation is symmetrically separated into a first group of wires for transmitting a first image signal and a second group of wires for transmitting a second image signal. The first group of wires are connected to one side of corresponding source drive integrated circuits and the second group of wires are connected to the other side of corresponding source drive integrated circuits.

### BACKGROUND OF THE INVENTION

1. Field of the Invention

The present invention relates to a liquid crystal display, and more particularly to a liquid crystal display (LCD) having improved wire structure for image transmission to minimize data signal and control signal delays and the electromagnetic interference(EMI) on a source printed circuit board.

2. Description of the Related Art

Recently, an LCD utilizing electrical and optical characteristics of liquid crystal has become popular as a display and developed to have a high resolution and a large screen size.

LCD devices comprise a liquid crystal panel for displaying an image, a display unit coupled to the panel and having driving chips mounted thereon, an optical assembly for projecting a light into the panel, and a case for assembling the panel, display unit, and optical assembly.

In the driving chips of the display unit, a timing controller plays an important role in outputting an image signal for a picture When the image signal is at a high frequency, the LCD screen images are highly affected by the EMI.

A large screen size and high resolution LCD requires a high frequency driver chip. However, the higher frequency driving chip costs more to fabricate, thereby increasing the price of the device.

In order to solve this problem, a method called frequency division is devised. As an example, in an LCD module with ten (10) source drive integrated circuits (ICs), a first image signal bus is coupled to all the odd numbered source drive ICs, a second image signal bus is coupled to all the even numbered source drive ICs. And an image signal that is output from a timing controller is supplied to the first image signal bus and the second image signal bus. Then, the image signal is sequentially latched to the ten (10) source drive ICs and data corresponding to one line of the latched signal is output from each of the ten (10) source drive ICs to an LCD panel.

The above described method makes the frequency of the image signal which is output from the timing controller lowered to a half compared with the image signal being output through a single image signal bus. This lessens the EMI influence, thereby obtaining a picture of high resolution by using a drive IC with a low operating frequency.

However, the conventional method has the following problems:

First, as the number of the image signal bus lines doubles the number of wires increases and the area or the number of layers of the circuit board needs to be increased to accommodate the wires, thereby increasing the fabrication cost.

Second, the buses for transmitting such image signal should be arranged along the same direction from the first source drive IC to the tenth source drive IC, which causes the coupling effect with the adjacent image signals by a parasitic capacitance, thereby delaying the signal transmission.

The changes in the signal transmission method may not totally eliminate the above problems but just improves the conditions of the conventional devices.

### SUMMARY OF THE INVENTION

It is therefore an object of the present invention to minimize the EMI.

It is another object of the invention to prevent a parasitic capacitance.

It is a further object of the invention to decrease a signal transmission delay.

It is a still further object of the invention to divide an image signal of one frame into a plurality of image signals regardless of the area and the number of the layers of the printed circuit board.

To achieve the above objects and other advantages, an LCD device of the present invention that comprises: a printed circuit board having a plurality of wires for transmitting the signals and/or voltages of the signal processor to the data signal driver. The wires comprise a first group of wires that transmit the first image signal and a second group of wires that transmits the second image signal and the first group of wires are separated from the second group of wires.

The first group wires and the second group wires are arranged in a T-shape on the printed circuit board.

### BRIEF DESCRIPTION OF THE DRAWINGS

The above object and other advantages of the present invention will become more apparent by describing in detail the preferred embodiments thereof with reference to the accompanying drawings, in which:

FIG. 1 is a simplified perspective view of the LCD in accordance with one preferred embodiment of the present invention;

FIG. 2 is a block diagram showing a circuit configuration of the LCD of FIG. 1;

FIG. 3 is a schematic diagram showing a wire configuration of the source printed circuit board in the LCD of the FIG. 1; and

FIG. 4 shows a waveform that illustrates the driving of the LCD of FIG. 2.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those having skills in the art.

Hereinbelow, one preferred embodiment of the present invention is described with reference to the accompanying drawings.

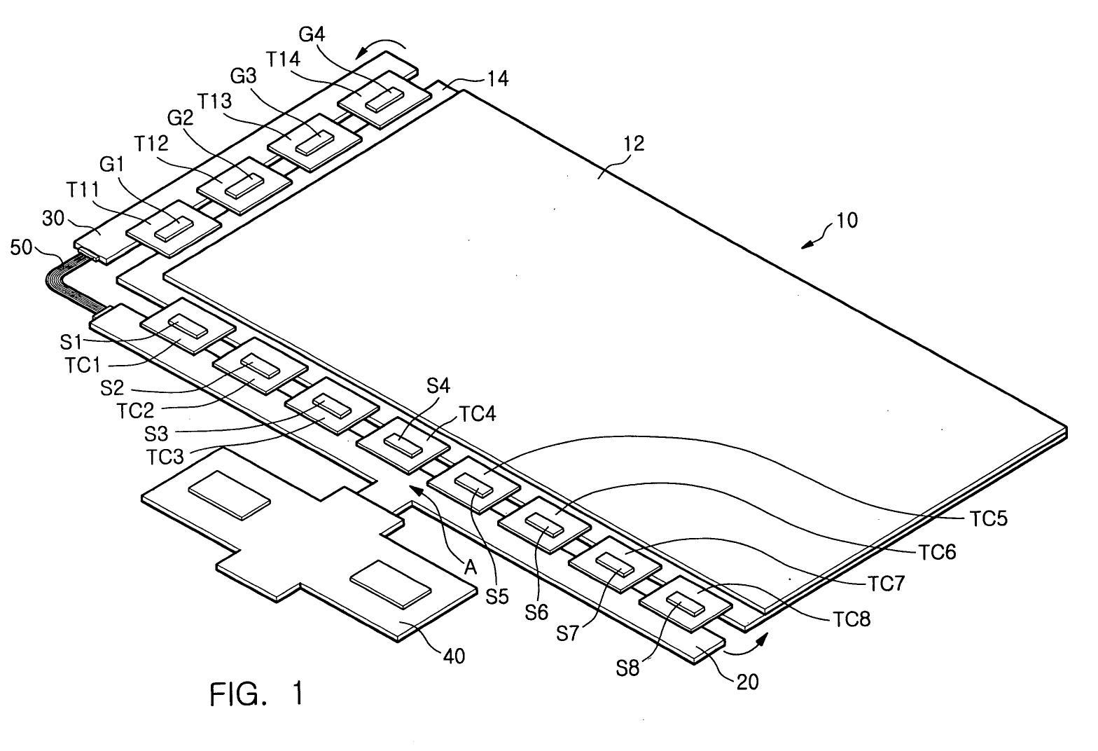

Referring to FIG. 1, an LCD includes an LCD panel 10 for displaying an image and two printed circuit boards coupled to the panel 10, for driving pixels of the panel 10. The two PCBs are coupled together by a connector 50.

The two PCBs are a source PCB 20 arranged along a horizontal direction of the panel 10 and a gate PCB 30 arranged along a vertical direction of the panel 10. The source PCB 20 and the gate PCB 30 are respectively coupled with the panel 10 by plural tape carrier packages. For the connection of the PCBs 20, 30 and the tape carrier packages, an anisotropic conductive film(not shown) is interposed therebetween.

Specifically, the gate PCB 30 is coupled to the panel 10 via tape carrier packages T11˜T14 on which gate drive integrated circuits G1˜G4 are respectively mounted and the source PCB 20 is coupled to the panel 10 via tape carrier packages TC1˜TC8 on which source drive integrated circuits S1˜S8 are respectively mounted.

The panel 10 has a structure that a color filter substrate 12 and a thin film transistor substrate 14 are attached to each other. A liquid crystal layer is disposed between the two substrates 12 and 14, and edges facing the two substrates 12 and 14 are sealed. The panel 10 can be divided into two regions, i.e., an effective display region corresponding to the area of the color filter substrate 12 and a non-effective display region not corresponding to the area of the color filter substrate 12 as viewed from the top. As shown in FIG. 1, the tape carrier packages T11˜T14, TC1˜TC8 are coupled to the non-effective region.

A flexible printed circuit (hereinbelow referred to as “FPC”) 40 is coupled to the source PCB 20. For electrical connection between the FPC 40 and the source PCB 20, edges of each of the FPC 40 and the source PCB 20 are overlapped with each other and a connecting member such as an anisotropic conductive film is provided therebetween.

In the above described LCD, the gate PCB 30 requires a plurality of wires that transmit a gate voltage for generating a gate signal and a control signal (hereinbelow referred to as gate control signal) for controlling an output of gate signal. The source PCB 20 also requires a plurality of wires that transmit a data voltage for generating a data signal and a control signal (hereinbelow referred to as data control signal) for outputting a gray scale voltage. Meanwhile, wires for transmitting any signals and devices having any functions may be additionally mounted on the gate PCB 20 and/or the data PCB 30, if necessary. Of course, the FPC 40 may include a gate voltage generating part, a gray scale voltage generating part, a timing controller, or a voltage supplying part.

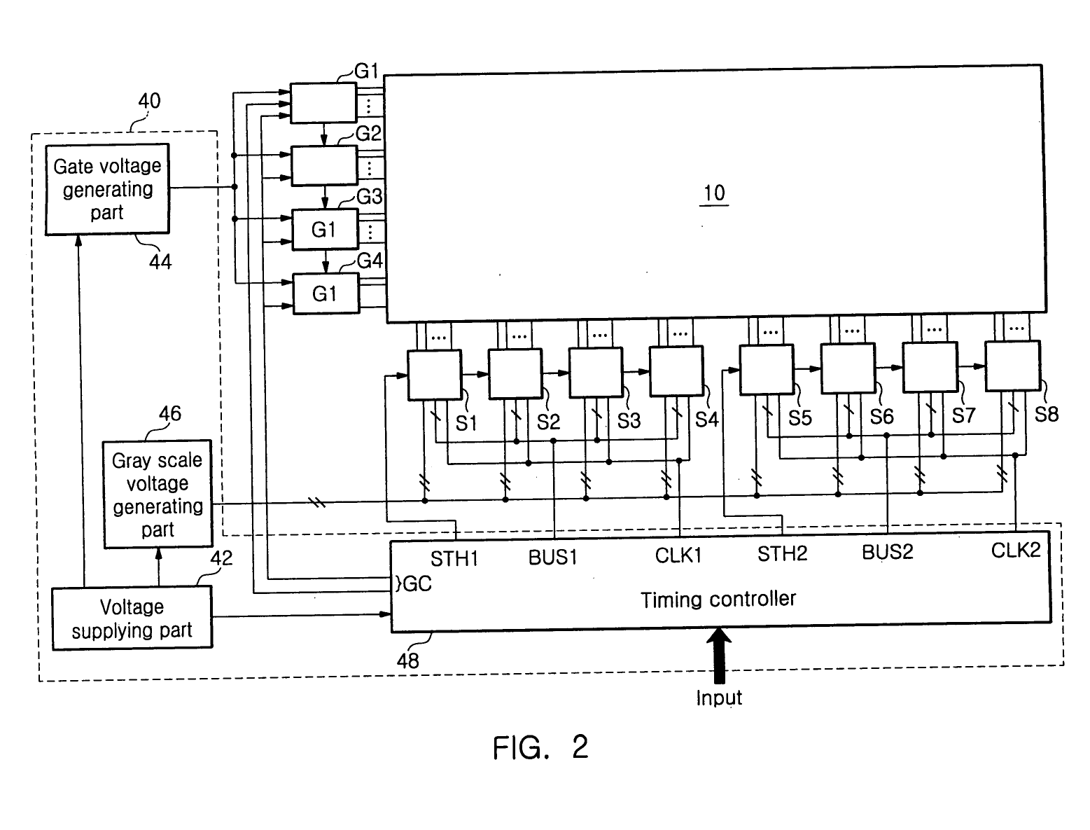

FIG. 2 is a block diagram of the circuitry within the liquid crystal display module.

Referring to FIG. 2, a voltage supplying part 42 transforms a constant voltage input from an image supplying source into a selected level and supplies the transformed voltage respectively to a gate voltage generating part 44, a gray scale voltage generating part 46, and a timing controller 48.

The gate voltage generating part 44 generates a turn-on or a turn-off voltages for turning-on or turning off gates of the thin films transistors formed on the thin film transistor substrate 14 of FIG. 1 and supplies them to the gate drive ICs G1˜G4 of the tape carrier packages. The gate drive ICs G1˜G4 sequentially outputs gate signals to the panel 10 under the control of the timing controller 48.

The gray scale voltage generating part 46 applies voltages of various levels to respective source drive ICs S1˜S8. For example, it requires positive voltages with 64 different voltage levels and negative voltages with 64 different voltage levels to display 64 gray scales. Accordingly, total 128 wires are required. Through these 128 wires, gray scale voltages are respectively applied to the respective source drive ICs S1˜S8.

The timing controller 48 creates a first image signal and a second image signal using both control data and image data that are supplied from an image data supplying source (not shown). The first image data and the second image data are supplied to respective source drive ICs S1˜S8.

The source drive ICs S1˜S8 latch data corresponding to one line of one frame image data and thereafter they output the latched data to the panel 10 simultaneously.

Each of the first image data output and the second image data output from the timing controller 48 includes a shift signal, color signals of R, G, and B, and clock signals. The first image signal is output from terminals STH1, BUS1, and CLK1 arranged in the timing controller 48 and the second image signal is output from terminals STH2, BUS2, and CLK2 arranged in the timing controller 48. The timing controller 48 also outputs a control signal for controlling the operation of the gate drive ICs G1˜G4 through a terminal GC.

Preferably, the clock signals CLK1 and CLK2 both have half a frequency of the main clock signal frequency of the image supplying source or the timing controller 48. The image supplying source or the timing controller 48 should be able to lower the frequency of input data into a half.

In the above described configuration, the voltage supplying part 42, the gate voltage generating part 44, the gray scale voltage generating part 46, and the timing controller 48 are all disposed on the FPC 40 of FIG. 1.

The source PCB 20 includes a plurality of wires (not shown) formed on one surface of the source PCB 20 as paths for transmitting signals into the source drive ICs S1˜S8 of the tape carrier package TC1˜TC8 and into the gate PCB 30. The gate PCB 30 also includes a plurality of wires (not shown) formed on one surface of the gate PCB 30 as a path for transmitting signals into the gate drive ICs G1˜G4.

The overlapped portion of the FPC 40 and the source PCB 20 is very narrower in width than the widths of the FPC 40 and the source PCB 20. Thus, wires of the FPC 40 are concentrated on the overlapped portion with a selected pattern.

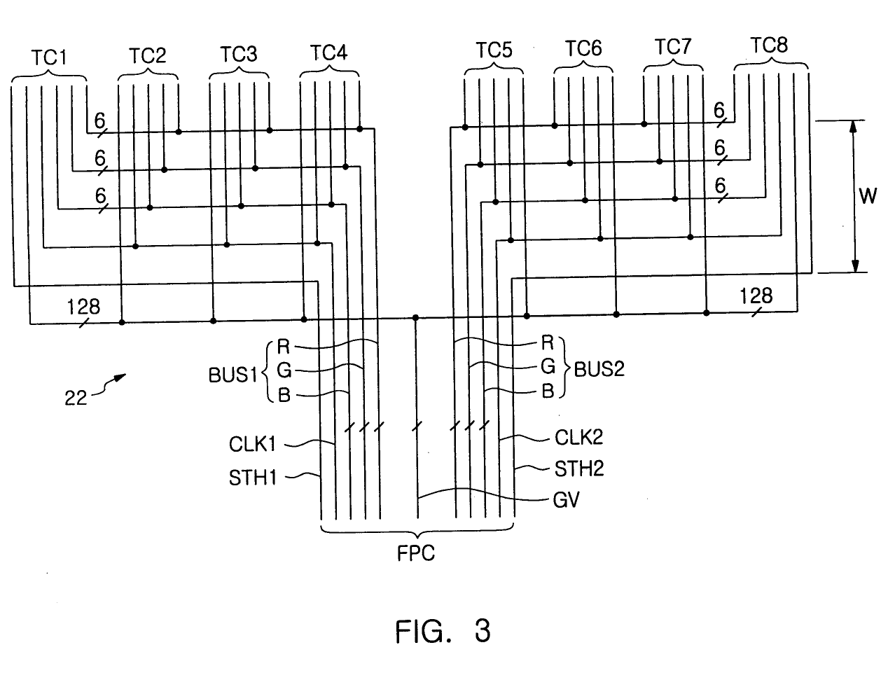

Among the wires formed on the source PCB 20, driving signal transmission wires for transmitting signals to be applied to the source drive integrated circuits S1˜S8 have a layout as shown in FIG. 3.

Referring to FIG. 3, signal transmission wires 22 are symmetrically divided into two groups. The first group of wires are connected with the tape carrier packages TC1˜TC4 that are respectively connected to source drive ICs S1˜S4. The second group of wires are connected with the tape carrier packages TC5˜TC8 that are respectively connected to source drive ICs S5˜S8. FIG. 3 also shows a wire GC for applying a gray scale voltage. The wire GC is arranged in a T-shape and connected to the respective source drive ICs S1˜S8.

Specifically, a wire for transmitting clock signals CLK1, a wire for transmitting data signals BUS1, and a wire for transmitting shift signals STH1 are respectively arranged at one region of the overlapped portion of the source PCB 20 and the FPC 40. At the other side, a wire for transmitting clock signals CLK2, a wire for transmitting data signals BUS2, and a wire for transmitting shift signals STH2 are respectively arranged. As described previously, the wire GC having 128 lines is disposed between wires of the two groups.

Among the wires, wires for transmitting signals contained in the first image signal, i.e., CLK1 and BUS1 are first folded to the left direction of FIG. 3 by approximately 90 degrees and then folded upward by approximately 90 degrees. The wires CLK1 and BUS1 are directly connected to the tape carrier package TC1 and are connected via another wires to the tape carrier packages TC2˜TC4. In other words, the tape carrier packages TC1˜TC4 are connected in parallel. Meanwhile, the wire STH1 for transmitting shift signals extends parallel with the wires CLK1 and BUS1 and is connected in series only to the tape carrier package TC1.

Likewise, wires for transmitting signals contained in the second image signal, i.e. CLK2 and BUS2 are first folded to the right direction of FIG. 3 by approximately 90 degrees and then folded upward by approximately 90 degrees. The wires CLK2 and BUS2 are directly connected to the tape carrier package TC8 and are connected via another wires to the tape carrier packages TC5˜TC7. In other words, the tape carrier packages TC5˜TC8 are connected in parallel. Meanwhile, the wire STH2 for transmitting shift signals extends parallel with the wires CLK2 and BUS2 and is connected in series only to the tape carrier package TC8.

Thus, the first group of wires and the second group of wires are formed on different regions of the source PCB 20. The first group of wires that transmit the first image signal is at a first region on which the tape carrier packages TC1˜TC4 are attached and the second group of wires that transmits the second image signal is at a second region on which the tape carrier package TC5˜TC8 are attached.

This configuration is made possible by driving at a frequency reduced to a half the source drive ICs S1˜S8 mounted on the tape carrier packages TC1˜TC8, respectively.

Accordingly, the voltage supplying part 42 applies a constant voltage to the gate voltage generating part 44 and the gray scale voltage generating part 46, and the timing controller 48 on the FPC 40. Then, the gate voltage generating part 44 generates a turn-on voltage having a DC level of an approximately 20V and a turn-off voltage having a DC level of an approximately −7V, and transmits the turn-on/turn-off voltages through wires formed on the source PCB 20, the gate PCB 30, and the tape carrier packages T11˜T14, whereby the turn-on/turn-off voltages are applied to the respective gate drive ICs G1˜G4.

The gray scale voltage generating part 46 generates constant voltages of 128 gray levels in order to display 64 gray scale levels. Constant voltages of 128 gray levels are transmitted via wires formed on the source PCB 20 and the tape carrier packages TC1˜TC8 and are applied to the respective source drive ICs S1˜S8.

The timing controller 48 generates first control signals and data signals both of which are being input to the source drive ICs S1˜S8, and second control signals which are being input to the gate drive ICs G1˜G4, using control data and image data input from image data supplying source. As a result, control signals including shift signals and clock signals for driving the gate drive ICs G1˜G4 are output through the terminal GC and first and second image signals for driving the source drive ICs S1˜S8 are also output through a corresponding terminal.

Thereafter, clock signal CLK1 contained in the first image signal and clock signal CLK2 contained in the second image signal are respectively applied to respective corresponding source drive ICs S1˜S8 and gray scale voltages are also applied to the source drive ICs S1˜S8.

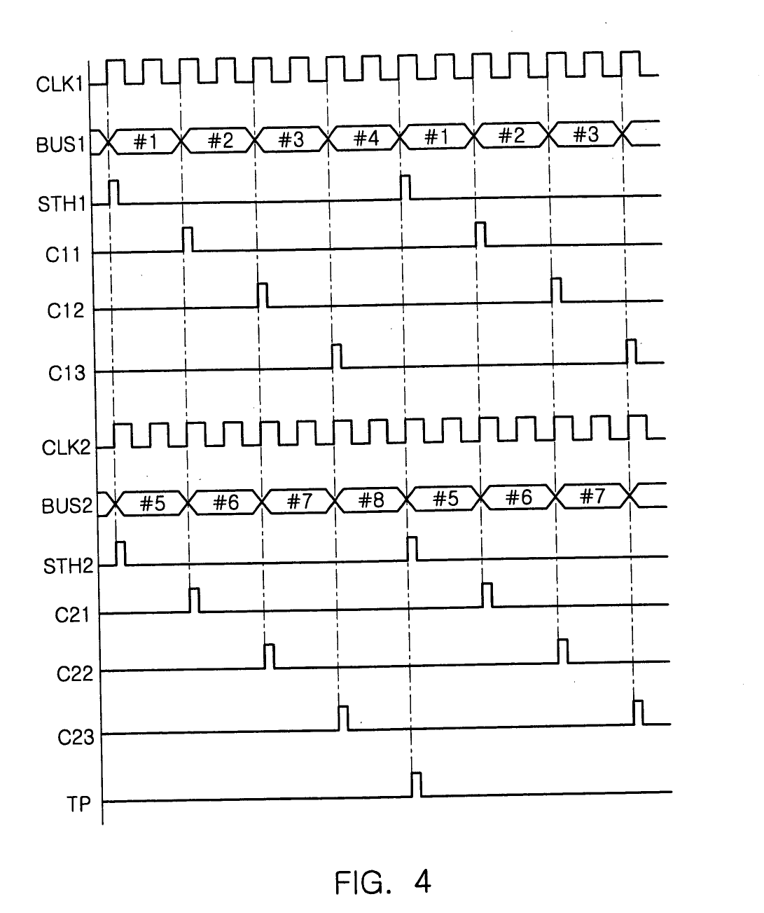

Referring to FIG. 4, clock signals CLK1 and CLK2 have the same phase and frequency with each other and are output from the timing controller 48. Each of the source drive ICs S1˜S8 latches data transmitted through the data bus BUS1 and BUS2 according to the shift signal or the carry out signal.

Specifically, through data bus BUS1 and BUS2, data to be input to the source drive ICs S1˜S4 and data to be input to the source drive ICs S5˜S8 are serially transmitted.

Together with the above signals, the shift signal STH1 is input to the source drive IC S1 as a carry-in signal. Then, the source drive IC S1 reads and latches a corresponding data #1 from data that have been serially transmitted via BUS 1. When the source drive IC S1 completes the latching, carry out signal C11 is accordingly generated and is input to the source drive IC S2 as a carry-in signal thereof. Then, the source drive IC S2 reads and latches data #2 from data that have been serially transmitted through the data bus BUS1. Likewise, as carry-out signals C12 and C13 are input to the source drive ICs S3 and S4. S3 and S4 respectively read and latch corresponding data #3 and data #4 from data that have been serially transmitted through BUS 1.

Similarly, the source drive ICs S5˜S8 respectively read and latch corresponding data #5, #6, #7, and #8 from data that has been serially transmitted through data bus BUS2, using shift signal STH2 and carry-out signals C21, C22, C23 generated from the shift signal STH2.

Here, the source drive ICs S1 and S5 concurrently read and latch the corresponding data #1 and data #5. As a result, it becomes possible to latch corresponding data by source drive ICs at a frequency half of the main clock signal frequency.

When all of the input data are latched at the respective source drive ICs S1˜S8, driving signal TP is applied to the respective source drive ICs S1˜S8 from the timing controller 66, whereby one line data stored in the respective source drive ICs S1˜S8 are concurrently output to LCD panel 10.

When one line data is output to the panel 10, a gate signal for the line data is also output to the panel 10 to turn on thin film transistors associated with the one line, whereby an image corresponding to the one line is displayed. Thus, one frame image can be displayed by sequentially scanning all lines corresponding to one frame image data.

According to the above described embodiment of the invention, source drive ICs are designed to be at a frequency half of the main clock signal frequency, which provides advantages to display a large-sized picture of high resolution.

Further, wires for transmitting the first image signal and the second image signal are divided into different regions, which provides an advantages to reduce the area and the number of layers of the source PCB. Specifically, in a conventional source PCB adopting a reduced frequency driving method, the first and the second group of wires for respectively transmitting the first and the second image signals are not separated into two regions but extend from the first source drive IC to the last source drive IC in parallel. Therefore, with the same interval between the wires, the conventional source PCB requires more area to accommodate the wires. That is, while the present source PCB has a width W, the conventional source PCB has a width 2 W. Thus, the present wiring configuration for the source PCB reduces area of the source PCB compared with the conventional wiring configuration for the source PCB. Moreover, in case the source PCB has a multi-layered structure and area of the source PCB is constant, the present source PCB may decrease the number of layers. As a result, the fabrication cost of the source PCB decreases.

Also, the symmetric structure of the wires in accordance with the present invention makes the wires short, which decreases the capacitance that causes a signal delay, whereby preventing the coupling effect and the EMI phenomenon.

While the above embodiment shows and describes an LCD having four gate drive ICs and eight source drive ICs, many alternative modifications and variations in their numbers may be possible.

This invention has been described above with reference to the aforementioned embodiment. It is evident, however, that many alternative modifications and variations will be apparent to those having skills in the art in light of the foregoing description. Accordingly, the present invention embraces all such alternative modifications and variations as fall within the spirit and scope of the appended claims.

1-8. (canceled)

9. A display apparatus comprising:
a signal processor for generating and outputting a first image signal, a second image signal and a driving control signal using an image data, a main control signal, and a power source all of which are supplied from an image supplying source, the driving control signal including a source driving control signal and a gate driving control signal;
a data signal driver for generating and outputting a data signal from the first or second image signal and the source driving control signal all of which are input from the signal processor, the data signal driver including a plurality of first source drive integrated circuits and a plurality of second source drive integrated circuits, the first source drive integrated circuits sequentially latching first corresponding data, the second source drive integrated circuits sequentially latching second corresponding data;
a printed circuit board having a plurality of wires for transmitting the signals of the signal processor to the data signal driver;
a gate signal driver for generating and outputting a gate signal from the gate driving control signal of the signal processor; and
a liquid crystal display panel for displaying an image formed by receiving the data signal from the data signal driver and the gate signal from the gate signal driver,
wherein the plurality of wires comprises a first group of wires for transmitting the first image signal and a second group of wires for transmitting the second image signal, and the first group of wires are entirely spaced apart from the second group of wires, and
wherein the data signal driver includes two groups of the data signal driver outputting simultaneously a data signal from the first image signal and the second image signal, one of which is the left-side of the signal processor and the other of which is the right-side of the processor.

10. The display apparatus of claim 9, wherein each of first source drive integrated circuits concurrently latch with each of the second source drive integrated circuits.

11. The display apparatus of claim 10, wherein the corresponding data has a frequency of a half of the main clock signal frequency.

12. The display apparatus of claim 9, wherein the data signal driving means comprises at least four source drive integrated circuits and is physically, electrically connected to the panel by a connecting member mounting the source drive integrated circuits one to one, the connecting member including a first group connecting member and a second group connecting member symmetrically separated with respect to the first group connecting member, the first group connecting member being connected with the first group wires and the second group connecting member being connected with the second group wires.

13. The display apparatus of claim 12, wherein the first image signal includes a first clock signal and the second image signal includes a second clock signal, the first and second clock signals have a frequency corresponding to a half of a clock signal frequency supplied from the image supplying source.

14. The display apparatus of claim 12, wherein the first image signal includes a first shift signal and the second image signal includes a second shift signal, the first and second shift signals being respectively applied to one source drive integrated circuit of corresponding group of the source drive integrated circuits such that they have the same phase each other.

15. The display apparatus of claim 12, wherein the first image signal includes a first driving signal and the second image signals includes a second driving signal, the first and second drive signals being respectively applied to one source drive integrated circuit of corresponding group of the source drive integrated circuits such that they have the same phase each other.

16. The liquid crystal display apparatus of claim 12, wherein the first group wires and the second group wires are branched from an wire aggregation including a plurality of wires at a selected position.

17. The display apparatus of claim 9, wherein the printed circuit board is a source printed circuit board.

18. The display apparatus of claim 9, wherein the first group wires and the second group wires are arranged in a T-shape on the printed circuit board.

19. The display apparatus of claim 9, wherein edges of the printed circuit board and the signal processor is overlapped with each other.

20. The display apparatus of claim 19, wherein an anisotropic conductive film is interposed between the overlapped edges of the printed circuit board and the signal processor.

21. The display apparatus of claim 19, wherein the overlapped portion of the printed circuit board and the signal processor has narrower width than a remaining portion of the printed circuit board.

22. The display apparatus of claim 19, wherein the overlapped portion of the printed circuit board and the signal processor has narrower width than a remaining portion of the signal processor.

23. The display apparatus of claim 9, wherein the printed circuit board comprises a plurality of parts.

24. The display apparatus of claim 23, wherein the parts comprises a voltage supplying part, a gate voltage generating part, a gray scale voltage generating part and a timing controller.

25. The display apparatus of claim 9, wherein the printed circuit board is formed on a different substrate from a thin film transistor substrate of the liquid crystal display panel.

26. The display apparatus of claim 9, wherein the first and second image signals comprises a first clock signal and a second clock signal, respectively, and the first and second clock signals have the same phase and frequency with each other.

27. The display apparatus of claim 9, wherein the wires are formed on one surface of the printed circuit board.

28. A display apparatus comprising:
a signal processor for generating and outputting a first image signal, a second image signal and a driving control signal using an image data, a main control signal, and a power source all of which are supplied from an image supplying source, the driving control signal including a source driving control signal and a gate driving control signal;
a data signal driver for generating and outputting a data signal from the first or second image signal and the source driving control signal all of which are input from the signal processor, the data signal driver including a plurality of first source drive integrated circuits and a plurality of second source drive integrated circuits, the first source drive integrated circuits sequentially latching first corresponding data, the second source drive integrated circuits sequentially latching second corresponding data;
a printed circuit board having a plurality of wires for transmitting the signals of the signal processor to the data signal driver;
a gate signal driver for generating and outputting a gate signal from the gate driving control signal of the signal processor; and
a liquid crystal display panel for displaying an image formed by receiving the data signal from the data signal driver and the gate signal from the gate signal driver,
wherein the plurality of wires comprises a first group of wires for transmitting the first image signal and a second group of wires for transmitting the second image signal, and the first group of wires are entirely spaced apart from the second group of wires, and the first image signal and the second image signal being transmitted simultaneously, and
wherein the data signal driver comprises at least four source device integrated circuits and is physically, electrically connected to the liquid crystal display panel by a connecting member mounting the source drive integrated circuits one to one, wherein the connecting member includes a first group of connecting member and a second group connecting member, the first group of connecting member being connected with the first group of wires and the second group of connecting ember being connected with the second group of wires.

29. The display apparatus of claim 28, wherein each of first source drive integrated circuits concurrently latch with each of the second source drive integrated circuits.

30. The display apparatus of claim 29, wherein the corresponding data has a frequency of a half of the main clock signal frequency.

31. The display apparatus of claim 28, wherein the first image signal includes a first clock signal and the second image signal includes a second clock signal, and the first clock signal and the second clock signal have a frequency half of a clock signal frequency supplied from the image supplying source.

32. The display apparatus of claim 28, wherein the first image signal includes a first shift signal and the second image signal includes a second shift signal, the first shift signal and the second shift signal being respectively applied to a source drive integrated circuit of a corresponding group of the source drive integrated circuits such that the group of the source drive integrated circuits have the same phase.

33. The display apparatus of claim 28, wherein the first group of wires and the second group of wires are branched from an wire aggregation including a plurality of wires at a selected position.

34. The display apparatus of claim 28, wherein edges of the printed circuit board and the signal processor is overlapped with each other.

35. The display apparatus of claim 34, wherein an anisotropic conductive film is interposed between the overlapped edges of the printed circuit board and the signal processor.

36. The display apparatus of claim 34, wherein the overlapped portion of the printed circuit board and the signal processor has narrower width than a remaining portion of the printed circuit board.

37. The display apparatus of claim 34, wherein the overlapped portion of the printed circuit board and the signal processor has narrower width than a remaining portion of the signal processor.

38. The display apparatus of claim 28, wherein the printed circuit board comprises a plurality of parts.

39. The display apparatus of claim 38, wherein the parts comprises a voltage supplying part, a gate voltage generating part, a gray scale voltage generating part and a timing controller.

40. The display apparatus of claim 28, wherein the first and second image signals comprises a first clock signal and a second clock signal, respectively, and the first and second clock signals have the same phase and frequency with each other.

41. The display apparatus of claim 28, wherein the wires are formed on one surface of the printed circuit board.

42. A display apparatus comprising:
a signal processor for generating and outputting a first image signal, a second image signal and a driving control signal using an image data, a main control signal, and a power source all of which are supplied from an image supplying source, the driving control signal including a source driving control signal and a gate driving control signal;
a data signal driver for generating and outputting a data signal from the first or second image signal and the source driving control signal all of which are input from the signal processor, the data signal driver including a plurality of first source drive integrated circuits and a plurality of second source drive integrated circuits, the first source drive integrated circuits sequentially generating and receiving first carry out signals, the second source drive integrated circuits sequentially generating and receiving second carry out signals;
a printed circuit board having a plurality of wires for transmitting the signals of the signal processor to the data signal driver;
a gate signal driver for generating and outputting a gate signal from the gate driving control signal of the signal processor; and
a liquid crystal display panel for displaying an image formed by receiving the data signal from the data signal driver and the gate signal from the gate signal driver,
wherein the plurality of wires comprises a first group of wires for transmitting the first image signal and a second group of wires for transmitting the second image signal, and the first group of wires are entirely spaced apart from the second group of wires, and
wherein the data signal driver includes two groups of the data signal driver outputting simultaneously a data signal from the first image signal and the second image signal, one of which is the left-side of the signal processor and the other of which is the right-side of the processor.

43. The display apparatus of claim 42, wherein each of first source drive integrated circuits concurrently latch with each of the second source drive integrated circuits.
